(19) United States
(12) Patent Application Publication
(10) Pub. No.: US 2025/0376239 A1
(43) Pub. Date: Dec. 11, 2025

(54) ELECTRIC TRICYCLE DETACHABLE RICKSHAW SYSTEM

(71) Applicant: Dustin Gyger, San Clemente, CA (US)

(72) Inventor: Dustin Gyger, San Clemente, CA (US)

(21) Appl. No.: 18/735,701

(22) Filed: Jun. 6, 2024

(51) Int. Cl. B62K 27/00; B62K 5/027; B62K 27/16; B62M 6/45

(52) U.S. Cl. CPC B62K 27/003; B62K 27/16; B62M 6/45; B62K 5/027

(57) ABSTRACT

An electric tricycle includes a frame; a first wheel, a second wheel, and a third wheel, each of which are connected to the frame; a motor connected to the frame and configured to rotate at least one of the first wheel, the second wheel, or the third wheel so to propel the electric tricycle; and a tow hitch attached to the rear portion of the frame, wherein the tow hitch is configured to connect to a tongue of a trailer. The trailer for use with an electric tricycle includes a chassis; a tongue configured to attached to a tow hitch of the electric tricycle; a passenger seat; a brake light, wherein the brake light is configured to be synchronized with a brake light mounted directly to the electric tricycle.

### TECHNICAL FIELD

The described embodiments relate generally to an apparatus and method for a detachable rickshaw system and more particularly to an apparatus and method for a detachable rickshaw system that is configured to connect to an electric tricycle.

### BACKGROUND INFORMATION

Electric tricycles, while efficient and convenient for various purposes, may not be well suited for transporting multiple passengers due to several key factors:

Limited Seating Capacity: Most electric tricycles are designed with a single rider in mind. The configuration typically includes a seat for the rider positioned directly above the motor and battery pack. This design limits the available space for additional passengers, making it challenging to accommodate more than one person comfortably.

Balance and Stability: Electric tricycles are inherently designed for stability, with two wheels at the rear providing a solid base of support. However, adding additional weight from passengers, especially on the rear of the tricycle, can affect its balance and stability. This imbalance may lead to handling issues, particularly during turns or maneuvers, potentially compromising safety.

Power and Performance: Electric tricycles are engineered with specific power and performance parameters optimized for single-rider operation. When carrying multiple passengers, the added weight increases the overall load on the tricycle's motor and battery, potentially reducing its efficiency and range. This can result in decreased acceleration, slower speeds, and shorter battery life, impacting the overall performance of the vehicle.

Legal and Safety Regulations: In many regions, electric tricycles are subject to regulations governing vehicle design, capacity, and safety standards. These regulations may restrict the number of passengers allowed on a tricycle based on factors such as seating arrangements, weight limits, and braking capabilities. Attempting to transport multiple passengers on a tricycle may violate these regulations, leading to legal repercussions and safety concerns.

Comfort and Ergonomics: Electric tricycles are typically designed with a single rider's comfort and ergonomics in mind. The seating position, handlebar placement, and overall layout of the vehicle are optimized for solo operation. Adding additional passengers may compromise comfort and ergonomics, as there may not be adequate space or support for multiple riders.

Risk of Overloading: Exceeding the recommended weight capacity of an electric tricycle can pose significant risks, including structural damage, component failure, and loss of control. Transporting multiple passengers increases the likelihood of overloading the tricycle, especially if the passengers are adults or carrying additional cargo. This can lead to mechanical issues, increased wear and tear, and potential safety hazards on the road.

Overall, while electric tricycles offer numerous benefits for individual transportation needs, they are not well suited for transporting multiple passengers due to limitations in seating capacity, balance and stability, power and performance, legal and safety regulations, comfort and ergonomics, and the risk of overloading.

A solution is needed to allow safe and efficient use of an electric tricycle for transportation of multiple passengers.

### SUMMARY

In a first novel aspect, an electric tricycle includes a frame; a first wheel, a second wheel, and a third wheel, each of which are connected to the frame; a motor connected to the frame and configured to rotate at least one of the first wheel, the second wheel, or the third wheel so to propel the electric tricycle; and a tow hitch attached to the rear portion of the frame, wherein the tow hitch is configured to connect to a tongue of a trailer.

In a second novel aspect, the trailer for use with an electric tricycle includes a chassis; a tongue configured to attached to a tow hitch of the electric tricycle; a passenger seat; a brake light, wherein the brake light is configured to be synchronized with a brake light mounted directly to the electric tricycle.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a side-view diagram of an electric tricycle with a tow hitch configured to tow a trailer that provides additional seating.

FIG. 2 is a zoomed-in diagram of the electric tricycle tow hitch and mating trailer tongue.

FIG. 3 is a front perspective view diagram of an electric tricycle with a tow hitch configured to tow a trailer that provides additional seating.

FIG. 4 is a rear perspective view diagram of an electric tricycle with a tow hitch configured to tow a trailer that provides additional seating.

FIG. 5 is a diagram of an electric tricycle electrical power drive system.

FIG. 6 is a flowchart diagram illustrating the method of use of an electric tricycle with a tow hitch configured to tow a trailer that provides additional seating.

FIG. 7 is a flowchart diagram illustrating the method of use of an electric tricycle with a tow hitch configured to tow a trailer that provides additional seating.

FIG. 8 is a flowchart diagram illustrating the method of use of an electric tricycle with a tow hitch configured to tow a trailer that provides additional seating.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

An electric tricycle is comprised of several interconnected parts that collaborate harmoniously to facilitate its operation. At its core lies the frame, a robust structure crafted from durable materials such as aluminum or steel, providing the foundation and support for all other components. Mounted on the frame are three wheels-one at the front for steering and two at the rear for stability. Propulsion of the tricycle may be provided by either the front wheel, the rear wheels, or all wheels, depending on the desired motor configuration.

Powering the electric tricycle is an electric motor, fueled by a rechargeable battery pack nestled within the frame or mounted nearby. The motor transforms electrical energy from the battery into mechanical power, propelling the tricycle forward when activated. To control speed and acceleration, the rider manipulates the throttle, which regulates the flow of power to the motor. When it's time to slow down or come to a stop, the rider applies the brakes, activating mechanical or hydraulic disc brakes mounted on the front and or rear wheels. A controller acts as the intermediary between the throttle, battery, and motor, orchestrating the flow of electricity to ensure seamless operation. Meanwhile, a display panel mounted on the handlebars provides real-time feedback on crucial metrics such as speed and battery level, empowering the rider with valuable information during their journey. Illuminating the path ahead are one or more headlights enhancing visibility in various lighting conditions. On the rear of the tricycle are one or more taillights providing visibility of the tricycle to others.

Steering control is achieved through the handlebars, which transmit the rider's input to the front wheel via a fork assembly. Completing the ensemble is the seat, offering comfort and support to the rider as they navigate the terrain. In concert, these components work in unison, transforming electrical energy into motion, enabling the rider to traverse distances with ease and efficiency.

The electric tricycle may also include a rear seat positioned above the rear wheels. The seat may be for a single passenger or large enough to carry multiple passengers. To improve ride quality and comfort, the seat may be attached to a shock absorber. To further improve the ride experience, the electric tricycle may have wheel fenders. Fenders are protective coverings mounted above the wheels to prevent water, mud, and debris from splashing onto the rider during operation. They help keep the rider clean and dry in various weather conditions.

For braking, the electric tricycle is equipped with a reliable braking system, which may include hydraulic or mechanical disc brakes mounted on the front or rear wheels. These brakes are operated using hand levers located on the handlebars, allowing the rider to apply braking force as needed.

For additional utility, at the rear of the tricycle, there is a specially designed tow hitch securely attached to the frame. This tow hitch is engineered to withstand the towing forces exerted by a trailer and provides a stable connection point for hitching the trailer.

In operation, the rider activates the tricycle by turning on the power and using the throttle to accelerate. The controller interprets the throttle input and adjusts the power output of the motor accordingly. As the motor engages, it propels the tricycle forward, with the rider steering using the handlebars to navigate. When the rider needs to slow down or stop, they apply the brakes, which reduce the speed of the tricycle by slowing down the rotation of the wheels. Throughout the operation, the battery supplies electrical energy to power the motor, with the display panel providing feedback on performance metrics such as speed and battery level. Overall, these components work together seamlessly to provide a smooth and efficient riding experience for the user.

One example of additional utility provided by the electric tricycle tow hitch is the ability to tow a trailer. The trailer is specifically designed to be towed by the electric tricycle and serves as an extension of its transport capacity. It consists of a robust chassis constructed from materials such as steel or aluminum, providing structural stability and durability. Mounted on the trailer chassis are additional seating accommodations, which may include bench-style seats or individual seats with seat belts for passenger safety. These seats are designed to comfortably accommodate passengers, increasing the overall capacity of the tricycle-trailer combination. The trailer also includes a storage compartment to store items in the trailer. The storage compartment may also be lockable so to protect items stored in the storage compartment from theft. Moreover, the seats on the tricycle may be foldable so to allow additional cargo capacity when the seats are not used by passengers.

For improved safety, integrated into the rear portion of the trailer are brake lights and turn signals that are synchronized with the corresponding signals on the electric tricycle. This synchronization ensures that other road users are aware of the tricycle's braking and turning intentions, enhancing overall safety during transportation.

The trailer may also include a battery that is configured to recharge the battery located on the electric tricycle. This extra trailer battery configuration is extremely helpful in extending the distance that can be traveled when the trailer's additional weight is being pulled by the electric tricycle.

The trailer may further include independent brakes so to aid the braking of the trailer independently. This may be very helpful when carrying heavy weight on the trailer. Relying solely on the braking power of the electric tricycle may not be sufficient to quickly stop the electric tricycle and trailer and could lead to accidents or injuries.

Depending on the design, the trailer may include additional features such as foldable seats for increased storage capacity when not in use, shock absorbers for enhanced stability during transportation, a canopy for weather protection, and a locking mechanism for securing valuables.

To operate the electric tricycle and trailer combination, the rider simply attaches the trailer to the tow hitch at the rear of the tricycle using a secure locking mechanism. Once connected, the rider can control both vehicles using the tricycle's throttle, brakes, and steering mechanism. The synchronized brake lights and turn signals ensure safe and efficient maneuvering on the road, while the additional seating provided by the trailer expands the tricycle's transport capacity for passengers or cargo.

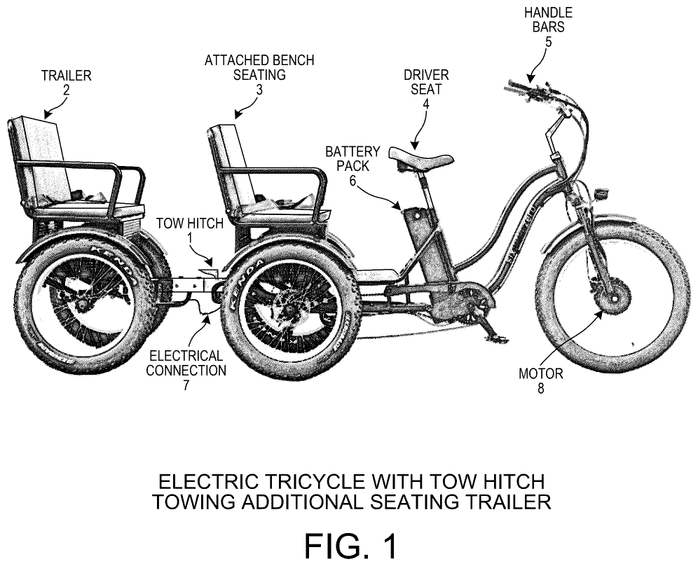

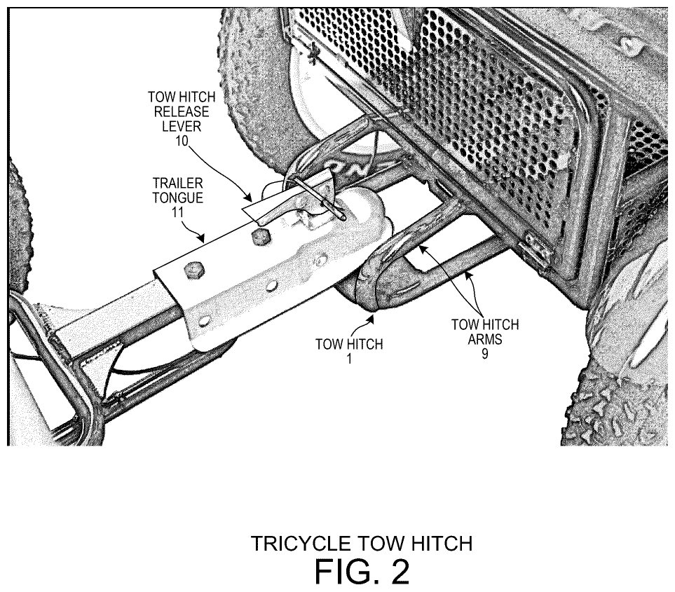

FIG. 1 is a side-view diagram of an electric tricycle with a tow hitch configured to tow a trailer that provides additional seating. The electric tricycle includes a tow hitch 1, a trailer 2, an attached bench seating 3, a driver seat 4, handle bars 5, battery pack 6, electrical connector 7, and motor 8. In operation, the driver of the electrical tricycle sits on the driver seat 4 and steers via handle bars 5. The handle bars 5 also include a throttle controller and instrument panel showing speed, range, or remaining battery charge. The throttle controller connects to the motor 8. When the throttle controller is adjusted, the speed at which the motor 8 rotates is also adjusted. The rotation of the wheel attached to the motor 8 causes the electric tricycle to be propelled. Additional passengers may sit on the attached bench seating 3 and may utilize included safety belts to prevent the passengers from falling from the electric tricycle. In the event additional seating is required, the electric tricycle includes a tow hitch 1 configured to attach to a trailer that includes additional seats. FIG. 2 is a zoomed-in diagram of the electric tricycle tow hitch and mating trailer tongue. The electric tricycle also includes an electrical connection/connector 7 that is used to conduct the brake signal from the electric tricycle to the trailer, so that the trailer brake light can be synchronized with the electric tricycle brake light. Seating on the trailer may also include safety belts to prevent trailer passengers from falling from the trailer seats.

To connect the trailer to the electric tricycle, the trailer tongue 11 is attached to the electric tricycle tow hitch 1. Once attached the tow hitch release lever 10 is closed and a safety pin is pushed into place, thereby preventing the tow hitch release lever from unintentionally opening during use. In one example, the tow hitch is secured to the electric tricycle via four metal tow hitch arms 9, as is illustrated in FIG. 2.

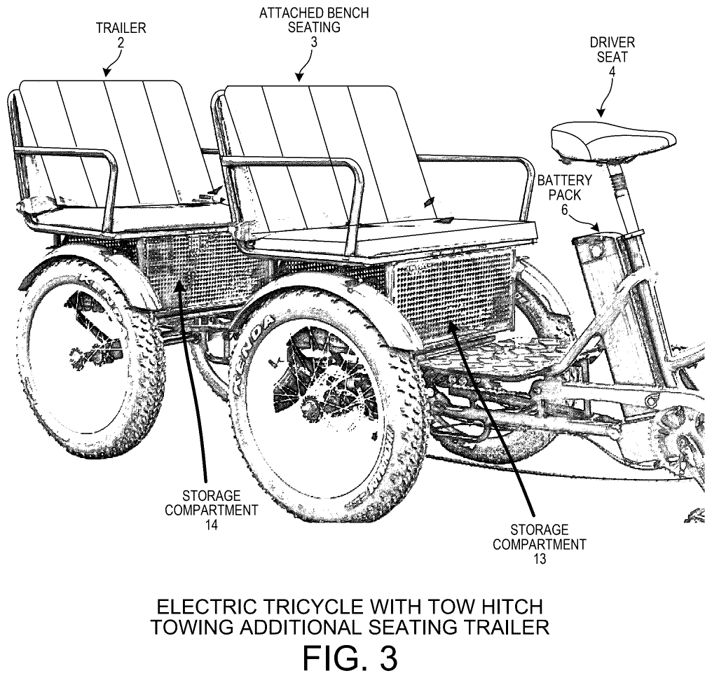

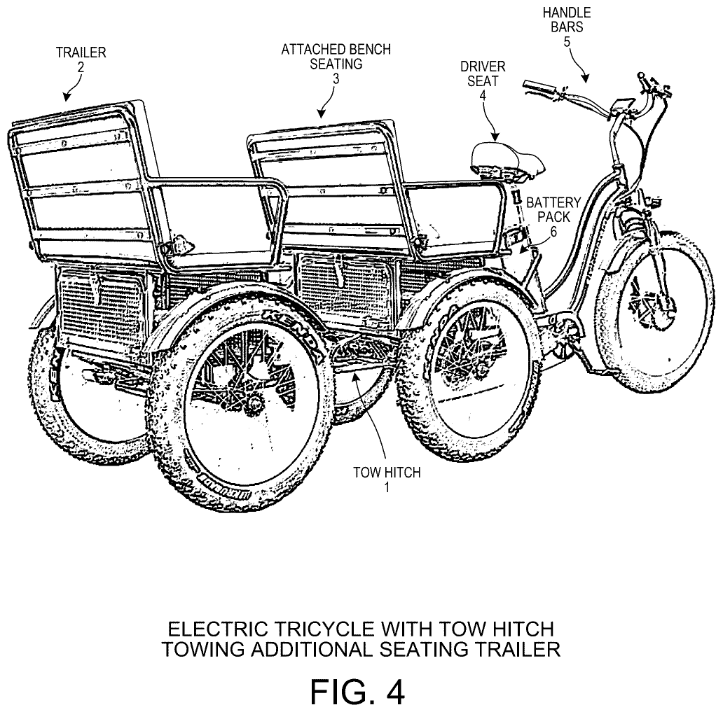

FIG. 3 is a front perspective view diagram of an electric tricycle with a tow hitch configured to tow a trailer that provides additional seating. FIG. 3 further illustrates storage compartment 13 included on the electric tricycle underneath the passenger seating, and storage compartment 14 included on the trailer underneath the passenger seating on the trailer. These storage compartments provide space to store items during transportation and are lockable so to prevent theft of the items stored therein. FIG. 4 is a rear perspective view diagram of an electric tricycle with a tow hitch configured to tow a trailer that provides additional seating. From the rear perspective view, the access doors to the storage compartments can be seen. The locking latch for each storage compartment door is also viewable.

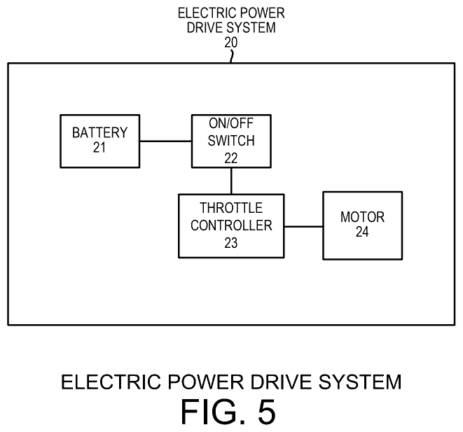

FIG. 5 is a diagram of an electric tricycle electrical power drive system. The electrical system includes a batter 21, an on/off power switch 22, a throttle controller 23, and a motor 24. In operation, the on/off power switch 22 connects or disconnects the battery output electrical potential from the throttle controller 23. When switch to the on position, the throttle controller 23 varies the amount of electrical potential applied to the motor 24, thereby controlling how fast motor 24 rotates. The rotational speed of motor 24 is directly related to the rate at which the one or more wheels attached to motor 8 will rotate. In this fashion, the electrical power drive system 20 controls the velocity of the electric tricycle.

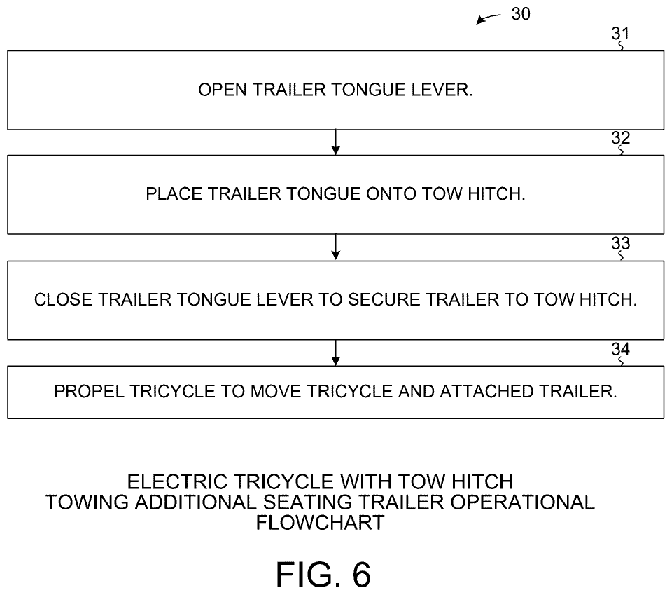

FIG. 6 is a flowchart diagram illustrating the method of use of an electric tricycle with a tow hitch configured to tow a trailer that provides additional seating. In step 31, the trailer tongue lever is opened. In step 32, the trailer tongue is placed onto the tow hitch. In step 33, the trailer tongue lever is closed to secure the trailer to the tow hitch. In step 34, the tricycle is propelled by the motor causing the attached trailer to be propelled as well.

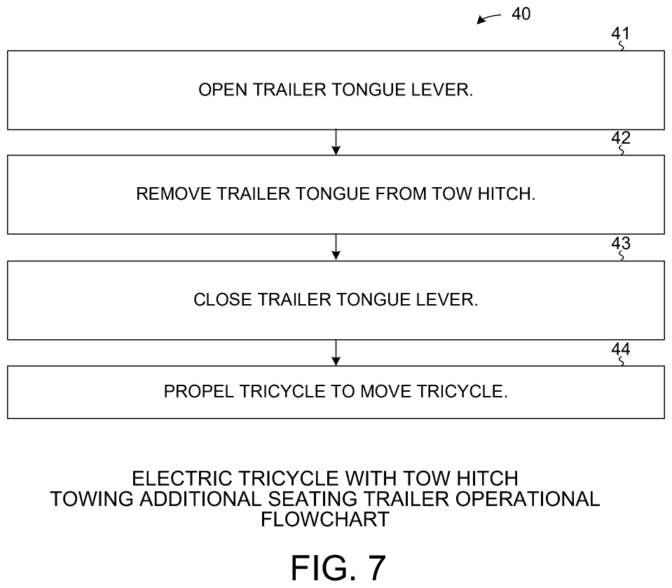

FIG. 7 is a flowchart diagram illustrating the method of use of an electric tricycle with a tow hitch configured to tow a trailer that provides additional seating. In step 41, the trailer tongue lever is opened. In step 42, the trailer tongue is removed from the tow hitch. In step 43, the trailer tongue lever is closed. In step 44, the electric tricycle is propelled while the trailer is not.

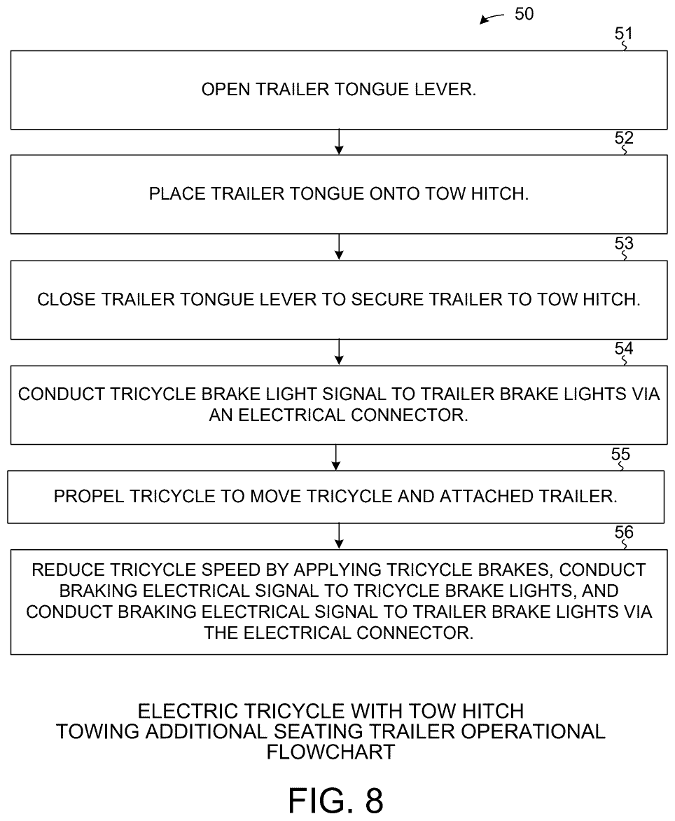

FIG. 8 is a flowchart diagram illustrating the method of use of an electric tricycle with a tow hitch configured to tow a trailer that provides additional seating. In step 51, the trailer tongue lever is opened. In step 52, the trailer tongue is placed onto the tow hitch. In step 53, the trailer tongue lever is closed to secure the trailer to the tow hitch. In step 54, the electric tricycle brake light signal is conducted to trailer brake light via the electrical connector. In step 55, the electric tricycle is propelled along with the attached trailer. In step 56, the electric tricycle speed is reduced by applying the electric tricycle brakes and the brake light signal is conducted to the trailer brake light via the electrical connector.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An electric tricycle comprising:
a frame;
a first wheel, a second wheel, and a third wheel, each of which are connected to the frame;
a motor connected to the frame and configured to rotate at least one of the first wheel, the second wheel, or the third wheel so to propel the electric tricycle; and
a tow hitch attached to the rear portion of the frame, wherein the tow hitch is configured to connect to a tongue of a trailer.

2. The electrical tricycle of claim 1, further comprising:
an electrical connector configured to conduct a brake signal from the electric tricycle to the trailer.

3. The electrical tricycle of claim 1, further comprising:
a driver's seat; and
a passenger seat, wherein the passenger seat is located behind the driver's seat.

4. The electrical tricycle of claim 1, further comprising:
a battery;
a power switch; and
a throttle controller, wherein the power switch is configured to connect or disconnect the battery from the throttle controller, and wherein the throttle controller is configured to control an amount of power applied to the motor.

5. The electric tricycle of claim 1, wherein said tow hitch includes a locking mechanism for securing the trailer connected to the tow hitch during transportation.

6. The electric tricycle of claim 1, wherein the tow hitch is adjustable to accommodate different trailer sizes.

7. The electric tricycle of claim 1, further comprising:
a storage bin located beneath the passenger seat configured to store items during transport.

8. The electric tricycle of claim 1, wherein the passenger seat is connected to a shock absorber for enhanced stability during transportation.

9. The electric tricycle of claim 1, further comprising:
a canopy configured to protect a passenger seated in the passenger seat from environmental elements.

10. The electric tricycle of claim 3, further comprising:
an adjustable seat belt for securing a passenger to the passenger seat during operation.

11. The electric tricycle of claim 7, wherein the storage bin is lockable and configured to prevent theft of an item stored in the storage bin.

12. A trailer for use with an electric tricycle, comprising:
a chassis;
a tongue configured to attached to a tow hitch of the electric tricycle;
a passenger seat; and
a brake light, wherein the brake light is configured to be synchronized with a brake light mounted directly to the electric tricycle.

13. The trailer of claim 12, wherein the passenger seat is foldable to provide increased storage capacity when not used by a passenger.

14. The trailer of claim 12, further comprising:
a turn signal synchronized with a turn signal of the electric tricycle.

15. The trailer of claim 12, further comprising:
a shock absorber for enhanced stability during transportation.

16. The trailer of claim 12, further comprising:
a canopy configured to protect a passenger seated in the passenger seat from environmental elements.

17. The trailer of claim 12, further comprising:
a battery configured to recharge the electronic tricycle's battery during transportation.

18. The trailer of claim 12, further comprising:
an adjustable seat belt configured to secure a passenger during transportation.

19. The trailer of claim 12, wherein the brake light is integrated into a rear portion of the trailer for improved visibility.

20. The trailer of claim 12, further comprising:
a storage bin located beneath the passenger seat configured to store items during transport, wherein the storage bin is lockable and configured to prevent theft of an item stored in the storage bin.
